(19) United States
(12) Patent Application Publication
(10) Pub. No.: US 2023/0197302 A1
(43) Pub. Date: Jun. 22, 2023

(54) CORE PERFORMANCE CALCULATION APPARATUS

(71) Applicant: Hitachi-GE Nucler Energy, Ltd., Ibaraki (JP)

(72) Inventor: Kazuya ISHII, Tokyo (JP)

(21) Appl. No.: 17/994,576

(22) Filed: Nov. 28, 2022

(30) Foreign Application Priority Data
Dec. 16, 2021 (JP) 2021-204033

(51) Int. Cl. G21C 17/00

(52) U.S. Cl. CPC G21C 17/00

(57) ABSTRACT

A core performance calculation apparatus includes: a nuclear constant storage device that stores nuclear constants that have been evaluated in advance in analysis of a fuel assembly; and a three-dimensional core nuclear thermal-hydraulic characteristics analysis device that obtains core characteristics including a power of the fuel assembly. The nuclear constant storage device stores, as the nuclear constants, response relationships between a neutron that flows into a fuel assembly cell and fuel assembly nuclear characteristics, and response relationships between a neutron that is produced from a fuel rod and the fuel assembly nuclear characteristics. The three-dimensional core nuclear thermal-hydraulic characteristics analysis device obtains a neutron effective multiplication factor by using the response relationships that have been stored in the nuclear constant storage device, and obtains the power of the fuel assembly by using the neutron effective multiplication factor.

### CROSS-REFERENCE TO RELATED APPLICATION

The present application claims priority from Japanese application JP2021-204033, filed on Dec. 16, 2021, the contents of which is hereby incorporated by reference into this application.

### BACKGROUND

### Technical Field

The present invention relates to a core performance calculation apparatus that monitors an operation state of a nuclear reactor.

### Related Art

An object of core performance calculation is to calculate a three-dimensional power distribution in a core of a nuclear reactor, by using data that has been measured in a plant, evaluate a power of each fuel assembly or each fuel rod, and confirm that the nuclear reactor is being operated in a state where the power is less than or equal to a thermal limit value that has been set in advance (see, for example, Patent Literature 1).

Core performance calculation is periodically performed at predetermined time intervals of, for example, one hour to six hours, or is appropriately performed in response to a user's request, and therefore an operation state of the nuclear reactor at a certain point in time can be checked.

A conventional core performance calculation method is described below.

First, state data of a core of a nuclear reactor, such as a flow rate of the core, a thermal power of the core, or positions of control rods, plant data such as measured values of neutron detectors, nuclear constants, such as neutron infinite multiplication factors or macroscopic cross sections, that have been calculated in advance for each fuel assembly, and other required data are read. Here, nuclear constants to be input have been stored in a table form by using parameters such as burnup or moderator density.

Next, the distribution of the flow rate to each of the fuel assemblies is calculated, and a void distribution is calculated.

Moreover, a distribution of moderator density is calculated from the void distribution, and nuclear constants for each node are calculated from the moderator density, the burnup, or the like, by using the nuclear constants that have already been read. The nodes have been obtained by dividing an inside of the core in units of a fuel assembly in a height direction.

Next, a three-dimensional neutron flux distribution in the core is obtained according to a diffusion equation, by using the calculated nuclear constants, and a power distribution is calculated from the neutron flux distribution.

By doing this, the power distribution in the core can be calculated.

In the process described above for calculating the power distribution, a power distribution in the height direction (an axial direction) is corrected to match the measured values of the neutron detectors.

However, a power distribution in a horizontal direction (a radial direction) is not corrected.

Accordingly, for the power distribution in the horizontal direction (the radial direction), it is requested that a power distribution before correction be precisely evaluated.

### CITATION LIST

### Patent Literature

Patent Literature 1: JP H11-295473 A

### SUMMARY

Meanwhile, in recent years, cores in which fuel assemblies that are significantly different in enrichment have been mixed and loaded or cores in which a uranium fuel assembly and a mixed oxide fuel assembly (a MOX fuel assembly) have been mixed and loaded have come into public use. In such a core, adjacent fuel assemblies are significantly different in nuclear characteristics.

On the other hand, nuclear constants, such as macroscopic cross sections, to be used in conventional core performance calculation, are evaluated under the assumption that adjacent fuel assemblies are the same as each other, and are spatially homogenized in a fuel assembly cell including a half region of a gap between fuel assemblies. Moreover, the three-dimensional neutron flux distribution is calculated according to the diffusion equation using the nuclear constants, and therefore an error is generated due to diffusion approximation.

Accordingly, with regard to a core in which adjacent fuel assemblies are significantly different in nuclear characteristics, the assumption of evaluation of nuclear constants is significantly different from an actual state, and therefore precision decreases due to homogenization of the nuclear constants and diffusion approximation.

In order to solve the problem described above, the present invention provides a core performance calculation apparatus that is capable of obtaining a power distribution in a core with high precision.

Furthermore, the object described above and other objects of the present invention and novel features of the present invention will become apparent from the description herein and the attached drawings.

A core performance calculation apparatus according to the present invention includes: a nuclear constant storage device that stores nuclear constants that have been evaluated in advance in analysis of a fuel assembly; and a three-dimensional core nuclear thermal-hydraulic characteristics analysis device that obtains core characteristics including a power of the fuel assembly.

In the core performance calculation apparatus according to the present invention, the nuclear constant storage device stores, as the nuclear constants, response relationships between a neutron that flows into a fuel assembly cell and fuel assembly nuclear characteristics, and response relationships between a neutron that is produced from a fuel rod and the fuel assembly nuclear characteristics, and the three-dimensional core nuclear thermal-hydraulic characteristics analysis device obtains a neutron effective multiplication factor by using the response relationships that have been stored in the nuclear constant storage device, and obtains the power of the fuel assembly by using the neutron effective multiplication factor.

By employing the core performance calculation apparatus according to the present invention that has been described above, a power distribution in a core can be obtained with high precision.

In particular, even in the case of a core in which adjacent fuel assemblies are significantly different in nuclear characteristics, a power distribution in the core can be obtained with high precision.

Note that problems, configurations, and effects other than the above will become apparent from the description below of embodiments.

### BRIEF DESCRIPTION OF DRAWINGS

FIG. 1 is a schematic configuration diagram of a core performance calculation apparatus in Example 1 of the present invention;

FIG. 2 is a flowchart of an outline of a flow of power distribution calculation performed by a three-dimensional core nuclear thermal-hydraulic characteristics analysis device of the core performance calculation apparatus in Example 1 of the present invention;

FIG. 3 is a flowchart of an outline of a flow of power distribution calculation performed by a three-dimensional core nuclear thermal-hydraulic characteristics analysis device of a core performance calculation apparatus in Example 2 of the present invention; and

FIG. 4 is a flowchart of an outline of a flow of power distribution calculation according to a direct response matrix method.

### DETAILED DESCRIPTION

Embodiments and examples according to the present invention are described below by using writing or drawings. However, structures, materials, various other specific configurations, or the like provided in the present invention are not limited to the embodiments or examples described herein, and combinations or modifications can be appropriately made without departing from the gist. Furthermore, the illustration of elements that are not directly related to the present invention is omitted.

A core performance calculation apparatus according to the present invention includes: a nuclear constant storage device that stores nuclear constants that have been evaluated in advance in analysis of a fuel assembly; and a three-dimensional core nuclear thermal-hydraulic characteristics analysis device that obtains core characteristics including a power of the fuel assembly.

In the core performance calculation apparatus according to the present invention, the nuclear constant storage device stores, as the nuclear constants, response relationships between a neutron that flows into a fuel assembly cell and fuel assembly nuclear characteristics, and response relationships between a neutron that is produced from a fuel rod and the fuel assembly nuclear characteristics, and the three-dimensional core nuclear thermal-hydraulic characteristics analysis device obtains a neutron effective multiplication factor by using the response relationships that have been stored in the nuclear constant storage device, and obtains the power of the fuel assembly by using the neutron effective multiplication factor.

By employing the core performance calculation apparatus according to the present invention, the response relationships between the neutron that flows into the fuel assembly cell and the fuel assembly nuclear characteristics, and the response relationships between the neutron that is produced from the fuel rod and the fuel assembly nuclear characteristics are stored as the nuclear constants, the neutron effective multiplication factor is obtained by using these stored response relationships, and the power of the fuel assembly is obtained by using the neutron effective multiplication factor.

By doing this, the response relationships between the neutron that flows into the fuel assembly cell and the fuel assembly nuclear characteristics, and the response relationships between the neutron that is produced from the fuel rod and the fuel assembly nuclear characteristics are not homogenized in the fuel assembly cell. Therefore, the assumption of evaluation of the nuclear constants can also be adapted to a core in which adjacent fuel assemblies are different in nuclear characteristics, and can be applied without problems.

Furthermore, diffusion approximation is not used in calculating a power distribution. Therefore, an error is not generated due to diffusion approximation, and a power distribution in a core can be obtained with high precision.

In particular, even in the case of a core in which adjacent fuel assemblies are significantly different in nuclear characteristics, a power distribution in the core can be obtained with high precision.

In the configuration of the core performance calculation apparatus described above, the three-dimensional core nuclear thermal-hydraulic characteristics analysis device can further be configured to perform: calculating out-going neutron current by using the response relationships between the neutron that flows into the fuel assembly cell and the fuel assembly nuclear characteristics, the response relationships between the neutron that is produced from the fuel rod and the fuel assembly nuclear characteristics, in-coming neutron current, a fuel rod neutron production rate, and the neutron effective multiplication factor, and updating the fuel rod neutron production rate; setting the in-coming neutron current of each node to the out-going neutron current of an adjacent node; and repeating the calculating of the out-going neutron current and the updating of the fuel rod neutron production rate, until the in-coming neutron current, the out-going neutron current, and the fuel rod neutron production rate have converged.

Stated another way, in the case of this configuration, even if a response matrix that would be obtained in the direct response matrix method described later is not obtained, neutron current and the fuel rod neutron production rate can be obtained. Accordingly, a calculation amount can be significantly reduced, and a calculation time can be significantly reduced, in comparison with a case where the response matrix is obtained by employing the direct response matrix method.

In the configuration of the core performance calculation apparatus described above, the response relationships with the fuel assembly nuclear characteristics can further be a response relationship between the neutron that flows into the fuel assembly cell and a neutron that flows out from the fuel assembly cell, a response relationship between the neutron that flows into the fuel assembly cell and the neutron that is produced from the fuel rod, a response relationship between the neutron that is produced from the fuel rod and a neutron that is produced from another fuel rod due to a fission reaction that has been induced by the neutron that is produced from the fuel rod, and a response relationship between the neutron that is produced from the fuel rod and the neutron that flows out from the fuel assembly cell.

Stated another way, in the case of this configuration, even if a response matrix that would be obtained in the direct response matrix method described later is not obtained, neutron current and the fuel rod neutron production rate can be obtained by using four types of response relationships. Accordingly, a calculation amount can be significantly reduced, and a calculation time can be significantly reduced, in comparison with a case where the response matrix is obtained by employing the direct response matrix method.

In the configuration of the core performance calculation apparatus described above, the three-dimensional core nuclear thermal-hydraulic characteristics analysis device can further be configured to obtain the neutron effective multiplication factor, by using a response relationship between the neutron that flows into the fuel assembly cell and neutron flux, a response relationship between the neutron that flows into the fuel assembly cell and macroscopic cross sections, a response relationship between the neutron that is produced from the fuel rod and the neutron flux, and a response relationship between the neutron that is produced from the fuel rod and the macroscopic cross sections.

Stated another way, in the case of this configuration, the neutron effective multiplication factor can be directly evaluated by using response relationships with the neutron flux or the macroscopic cross sections. Therefore, convergence of the neutron effective multiplication factor can be improved, and a calculation time can be significantly reduced, in comparison with a method for performing adjustment on the basis of an increase/decrease in the neutron current.

In the configuration of the core performance calculation apparatus described above, the response relationships with the fuel assembly nuclear characteristics can be a response relationship between the neutron that flows into the fuel assembly cell and a neutron that flows out from the fuel assembly cell, a response relationship between the neutron that flows into the fuel assembly cell and the neutron that is produced from the fuel rod, a response relationship between the neutron that is produced from the fuel rod and a neutron that is produced from another fuel rod due to a fission reaction that has been induced by the neutron that is produced from the fuel rod, a response relationship between the neutron that is produced from the fuel rod and the neutron that flows out from the fuel assembly cell, a response relationship between the neutron that flows into the fuel assembly cell and neutron flux, a response relationship between the neutron that flows into the fuel assembly cell and macroscopic cross sections, a response relationship between the neutron that is produced from the fuel rod and the neutron flux, and a response relationship between the neutron that is produced from the fuel rod and the macroscopic cross sections.

Stated another way, in the case of this configuration, even if a response matrix that would be obtained in the direct response matrix method described later is not obtained, neutron current and the fuel rod neutron production rate can be obtained by using response relationships between neutrons. Accordingly, a calculation amount can be significantly reduced, and a calculation time can be significantly reduced, in comparison with a case where the response matrix is obtained by employing the direct response matrix method. Furthermore, the neutron effective multiplication factor can be directly evaluated by using response relationships with the neutron flux or the macroscopic cross sections. Therefore, convergence of the neutron effective multiplication factor can be improved, and a calculation time can be significantly reduced, in comparison with a method for performing adjustment on the basis of an increase/decrease in the neutron current.

An example of a method for precisely evaluating the power distribution in the core is a method called the direct response matrix method.

In this method, the power distribution in the core is calculated by using, as the nuclear constants, four types of response relationships that have been obtained in advance in analysis using the fuel assembly cell as a target, instead of the macroscopic cross sections.

The four types of response relationships described above are a response relationship (T) between a neutron that flows into a fuel assembly cell and a neutron that flows out from the fuel assembly cell, a response relationship (S) between the neutron that flows into the fuel assembly cell and a neutron that is produced from a fuel rod, a response relationship (A) between the neutron that is produced from the fuel rod and a neutron that is produced from another fuel rod due to a fission reaction that has been induced by the neutron that is produced from the fuel rod, and a response relationship (L) between the neutron that is produced from the fuel rod and the neutron that flows out from the fuel assembly cell.

These four types of response relationships T, S, A, and L are expressed by a matrix, and are not homogenized in the fuel assembly cell.

Then, this direct response matrix method can be applied to the core performance calculation apparatus according to the present invention to calculate the power distribution. In a case where the direct response matrix method is applied to the core performance calculation apparatus according to the present invention, the four types of response relationships T, S, A, and L described above of the direct response matrix method are employed for the response relationships between the neutron that flows into the fuel assembly cell and the fuel assembly nuclear characteristics and the response relationships between the neutron that is produced from the fuel rod and the fuel assembly nuclear characteristics, that are stored in the nuclear constant storage device.

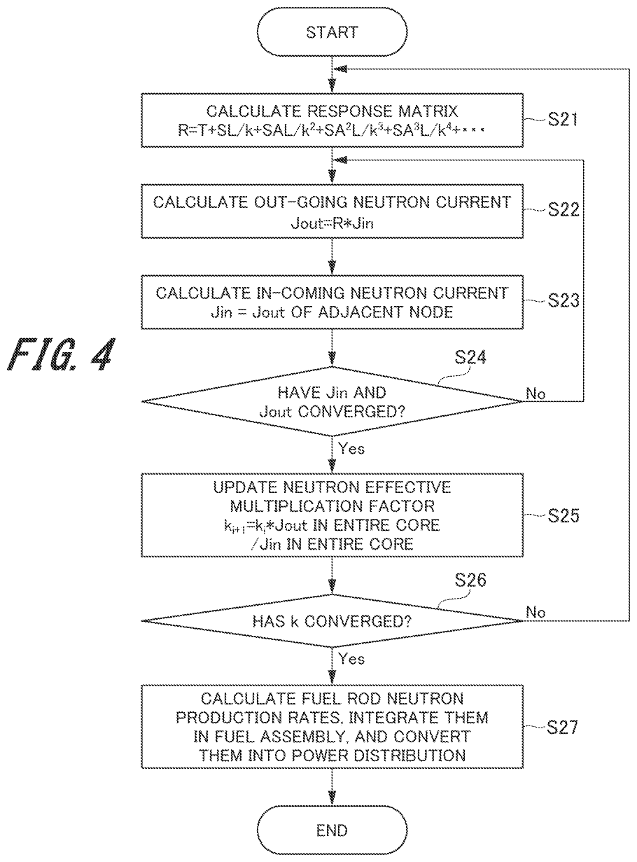

Here, a flowchart of an outline of a flow of power distribution calculation according to the direct response matrix method is illustrated in FIG. 4.

First, in step S21, a response matrix R of each node is calculated from the four types of response relationships T, S, A, and L, as expressed by Formula (11) described below.

R=T+SL/k+SAL/k²+SA²L/k³+SA³L/k⁴+ . . . (11)

where k is a neutron effective multiplication factor.

Next, in step S22, the response matrix R is multiplied by in-coming neutron current Jin for each of the nodes, and out-going neutron current Jout is obtained. Stated another way, the out-going neutron current Jout is obtained, as expressed by Formula (12) described below.

Jout=R*Jin (12)

Moreover, in step S23, the in-coming neutron current of each of the nodes is set to out-going neutron current of an adjacent node, and the in-coming neutron current Jin is calculated.

Stated another way, setting is performed in such a way that Jin=Jout of adjacent node.

This calculation of neutron current is repeated until convergence.

Stated another way, in step S24, it is determined whether the in-coming neutron current Jin and the out-going neutron current Jout have converged, and if the neutron currents have converged, the processing moves on to step S25, and if the neutron currents have not converged, the processing returns to step S22.

After the neutron currents have converged, in step S25, ratios of the out-going neutron current and the in-coming neutron current in the entire core are multiplied, and therefore the neutron effective multiplication factor k is updated. Stated another way, the neutron effective multiplication factor k is updated, as expressed by Formula (13) described below.

kᵢ₊₁=kᵢ*Jout in entire core/Jin in entire core (13)

where kᵢ is a neutron effective multiplication factor in i-th repetition, and kᵢ₊₁ is a neutron effective multiplication factor in (i+1)th repetition.

Next, a response matrix R is calculated by using the updated neutron effective multiplication factor k, and calculation of neutron current is repeated until the neutron effective multiplication factor k has converged.

Stated another way, in step S26, it is determined whether the neutron effective multiplication factor k has converged. In a case where the neutron effective multiplication factor k has not converged, the processing returns to step S21, and the response matrix R is calculated. In contrast, in a case where the neutron effective multiplication factor k has converged, the processing moves on to step S27.

After the neutron effective multiplication factor k has converged, a power distribution in a core is calculated by using the obtained in-coming neutron current and the response relationships.

Stated another way, in step S27, fuel rod neutron production rates are calculated. Then, the calculated fuel rod neutron production rates are integrated in the fuel assembly, and a result is converted into a power distribution.

By calculating a power distribution according to the direct response matrix method described above, a nuclear constant is not homogenized, and diffusion approximation is not used in calculating the power distribution. Therefore, the power distribution can be precisely calculated. Furthermore, even in the case of a core in which adjacent fuel assemblies are significantly different in nuclear characteristics, a power distribution in a core can be obtained with high precision.

However, the calculation of the power distribution according to the direct response matrix method illustrated in the flowchart of FIG. 4 has two problems described below from the viewpoint of application of the direct response matrix method to calculation of core performance.

A first problem is a significant calculation amount of calculation of the response matrix R.

In the formula illustrated in step S21 of FIG. 4 for obtaining the response matrix R, addition permanently continues. However, a higher-order term contributes less, and therefore addition can be stopped after addition of a realistic number of terms. However, it is requested that a matrix be integrated or added many times, and therefore a calculation amount is significant, and it takes significant time for calculation.

A second problem is low convergence of repetitive calculation for obtaining the neutron effective multiplication factor k.

Deviation of the neutron effective multiplication factor k from its convergence value is adjusted at a ratio of increasing or decreasing the neutron current by using the response matrix R.

However, part of the response matrix R is adjusted for the neutron effective multiplication factor k, and only part of deviation of the neutron effective multiplication factor k from the convergence value can be adjusted. Moreover, as the neutron effective multiplication factor k becomes closer to the convergence value, an amount of adjustment decreases, and it takes more time for convergence.

In view of this, in the core performance calculation apparatus according to the present invention, a configuration to solve the first problem described above or a configuration to solve the second problem described above can further be employed.

An example of the configuration to solve the first problem described above is a configuration in which it is assumed that a fuel rod neutron production rate is an unknown value, and in-coming/out-going neutron current and the fuel rod neutron production rate are obtained by using four types of response relationships.

By employing this configuration, calculation of the response matrix R can be omitted, a calculation amount can be significantly reduced, and a calculation time can be significantly reduced.

An example of the configuration to solve the second problem is a configuration in which new response relationships have been obtained in advance in analysis using a fuel assembly cell as a target, and the neutron effective multiplication factor is directly evaluated by using the new response relationships obtained in advance.

The new response relationships described above includes a response relationship (Fs) between a neutron that flows into the fuel assembly cell and neutron flux, a response relationship (Cs) between the neutron that flows into the fuel assembly cell and macroscopic cross sections, a response relationship (Ff) between a neutron that is produced from a fuel rod and the neutron flux, and a response relationship (Cf) between the neutron that is produced from the fuel rod and the macroscopic cross sections. Note that there are plural types of macroscopic cross sections such as neutron absorption cross sections or neutron production cross sections, and therefore a response relationship with the macroscopic cross sections is obtained for each type of macroscopic cross sections.

After the in-coming neutron current and the fuel rod neutron production rate have been obtained, neutron flux and macroscopic cross sections are obtained for each node by using these response relationships Fs, Cs, Ff, and Cf. The neutron effective multiplication factor is directly obtained as a ratio of a neutron production rate and a neutron absorption rate in the entire core, by using the neutron flux and the macroscopic cross sections of each of the nodes. By doing this, convergence can be improved, and a calculation time can be significantly reduced in comparison with a method for performing adjustment on the basis of an increase/decrease in neutron current according to the direct response matrix method.

Next, specific examples of the present invention are described below.

Note that in the examples described below, similarly to a case where the direct response matrix method is applied to the core performance calculation apparatus according to the present invention, an effect by which a power distribution can be precisely calculated is exhibited, and one of or both the two problems in a case where the direct response matrix method is applied to the core performance calculation apparatus according to the present invention can be solved.

### Example 1

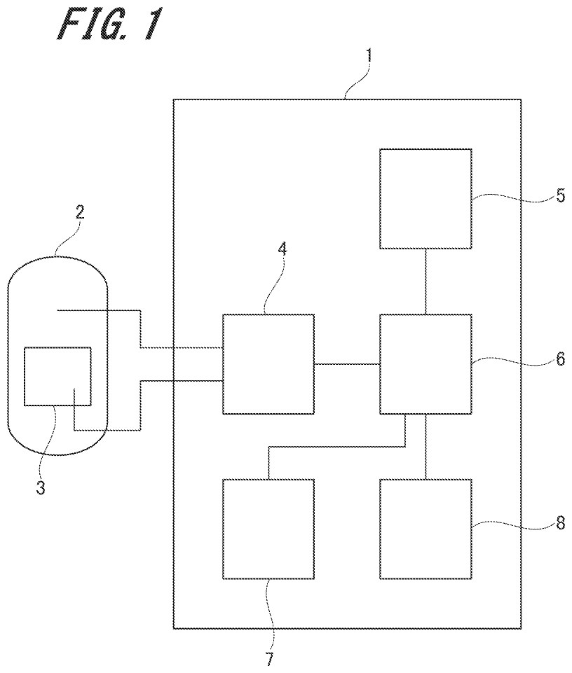

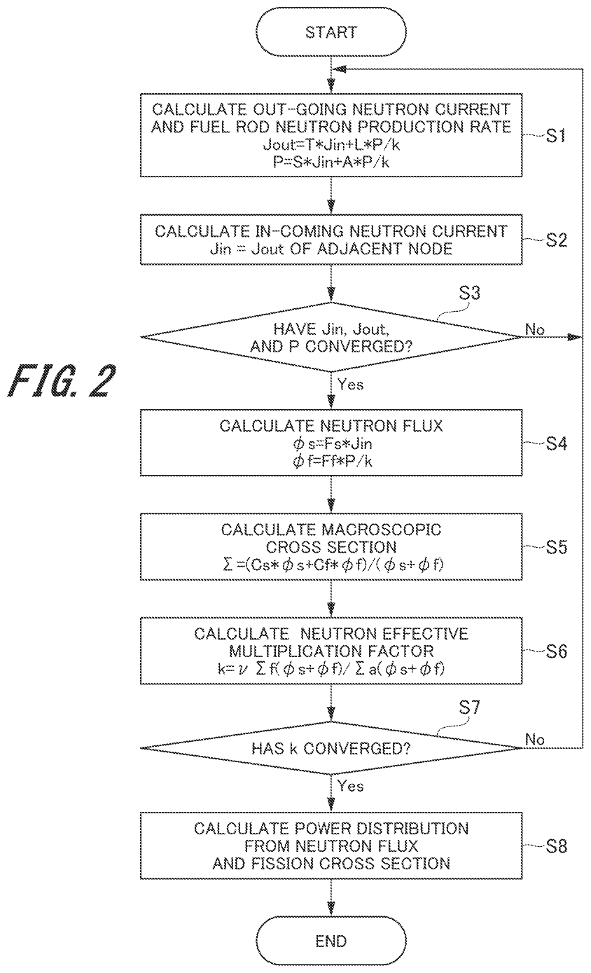

A core performance calculation apparatus in Example 1 of the present invention is described with reference to FIGS. 1 and 2.

FIG. 1 is a schematic configuration diagram of the core performance calculation apparatus in Example 1 of the present invention.

A core performance calculation apparatus 1 in the present example includes a plant data input device 4, a nuclear constant storage device 5, a three-dimensional core nuclear thermal-hydraulic characteristics analysis device 6, a request input device 7, and a display device 8.

Core state data and measured values of neutron detectors are input to the plant data input device 4 from a nuclear reactor 2 or a core 3.

In the nuclear constant storage device 5, nuclear constants that have been calculated for each fuel assembly has been stored in advance.

The three-dimensional core nuclear thermal-hydraulic characteristics analysis device 6 reads data from the plant data input device 4 and the nuclear constant storage device 5, and analyzes a power distribution or the like.

A request from an operator of the nuclear reactor, or the like is input to the request input device 7.

The display device 8 displays a result of analysis performed by the three-dimensional core nuclear thermal-hydraulic characteristics analysis device 6.

Note that the apparatus configuration illustrated in FIG. 1 is the same as a configuration of a conventional core performance calculation apparatus.

A difference from the conventional core performance calculation apparatus is the content of the nuclear constants stored in the nuclear constant storage device 5 and a calculation method employed in the three-dimensional core nuclear thermal-hydraulic characteristics analysis device 6.

In the nuclear constant storage device 5 in the present example, eight types of response relationships have been stored, instead of macroscopic cross sections or the like that have been homogenized in a fuel assembly cell, and have been stored in a nuclear constant storage device in the conventional core performance calculation apparatus.

The eight types of response relationships are the response relationship (T) between a neutron that flows into the fuel assembly cell and a neutron that flows out from the fuel assembly cell, the response relationship (S) between the neutron that flows into the fuel assembly cell and a neutron that is produced from a fuel rod, the response relationship (A) between the neutron that is produced from the fuel rod and a neutron that is produced from another fuel rod due to a fission reaction that has been induced by the neutron that is produced from the fuel rod, the response relationship (L) between the neutron that is produced from the fuel rod and the neutron that flows out from the fuel assembly cell, the response relationship (Fs) between the neutron that flows into the fuel assembly cell and neutron flux, the response relationship (Cs) between the neutron that flows into the fuel assembly cell and macroscopic cross sections, the response relationship (Ff) between the neutron that is produced from the fuel rod and the neutron flux, and the response relationship (Cf) between the neutron that is produced from the fuel rod and the macroscopic cross sections.

Here, a flowchart of an outline of a flow of power distribution calculation performed by the three-dimensional core nuclear thermal-hydraulic characteristics analysis device 6 of the core performance calculation apparatus in Example 1 of the present invention is illustrated in FIG. 2.

First, in step S1, out-going neutron current Jout is calculated by using four types of response relationships T, S, A, and L, in-coming neutron current Jin, a fuel rod neutron production rate P, and a neutron effective multiplication factor k, and the fuel rod neutron production rate P is updated.

Stated another way, the out-going neutron current Jout is calculated according to Formula (1) described below, and the fuel rod neutron production rate P is updated according to Formula (2).

Jout=T*Jin+L*P/k (1)

P=S*Jin+A*P/k (2)

Next, in step S2, in-coming neutron current of each node is set to out-going neutron current of an adjacent node, and the in-coming neutron current Jin is calculated.

Stated another way, setting is performed in such a way that Jin=Jout of an adjacent node.

This calculation of the neutron current and the fuel rod neutron production rate is repeated until convergence.

Stated another way, in step S3, it is determined whether the in-coming neutron current Jin, the out-going neutron current Jout, and the fuel rod neutron production rate P have converged. If they have converged, the processing moves on to step S4, and if they have not converged, the processing returns to step S1.

In step S4, neutron flux cps derived from an in-coming neutron and neutron flux φf derived from a neutron that has been produced from a fuel rod are calculated by using the calculated in-coming neutron current Jin, the updated fuel rod neutron production rate P, and two types of response relationships Fs and Ff.

Stated another way, the neutron flux cps derived from the in-coming neutron is calculated, as expressed by Formula (3), and the neutron flux φf derived from the neutron that has been produced from the fuel rod is calculated, as expressed by Formula (4).

φs=Fs*Jin (3)

φf=Ff*P/k (4)

Next, in step S5, two types of response relationships Cs and Cf are averaged by using, as weight, the neutron fluxes φs and φf calculated in step S4, and therefore a macroscopic cross section Σ is obtained. Stated another way, the macroscopic cross section Σ is obtained, as expressed by Formula (5) described below.

Σ=(Cs*φs+Cf*φf)/(φs+φf) (5)

Next, in step S6, a neutron effective multiplication factor k is directly obtained as a ratio of a neutron production rate and a neutron absorption rate in the entire core, by using the neutron fluxes φs and φf calculated in step S4 and the macroscopic cross section Σ obtained in step S5. Stated another way, the neutron effective multiplication factor k is obtained, as expressed by Formula (6) described below.

k=νΣf(φs+φf)/Σa(φs+φf) (6)

where νΣf is a neutron production cross section, and Σa is a neutron absorption cross section.

The above is repeated until the neutron effective multiplication factor k has converged.

Stated another way, in step S7, it is determined whether the neutron effective multiplication factor k has converged. In a case where the neutron effective multiplication factor k has not converged, the processing returns to step S1. In contrast, in a case where the neutron effective multiplication factor k has converged, the processing moves on to step S8.

After the neutron effective multiplication factor k has converged, in step S8, a power distribution in a core is calculated by using the obtained neutron fluxes and fission cross sections.

In the present example, the neutron effective multiplication factor k and a power distribution of a fuel assembly are obtained, by using, as nuclear constants, the response relationships T, S, A, L, Fs, Cs, Ff, and Cf, without using homogenized cross sections.

By doing this, the response relationships T, S, A, L, Fs, Cs, Ff, and Cf are not homogenized in a fuel assembly cell. Therefore, the assumption of evaluation of the nuclear constants can also be adapted to a core in which adjacent fuel assemblies are different in nuclear characteristics, and can be applied without problems.

Furthermore, diffusion approximation is not used in calculating a power distribution. Therefore, an error is not generated due to diffusion approximation, and a power distribution in a core can be obtained with high precision in comparison with a conventional core performance calculation apparatus.

In particular, even in the case of a core in which adjacent fuel assemblies are significantly different in nuclear characteristics, a power distribution in the core can be obtained with high precision.

Furthermore, in the present example, a response matrix that would be obtained in the direct response matrix method is not obtained, and the in-coming/out-going neutron currents Jin and Jout and the fuel rod neutron production rate P are obtained, by using four types of response relationships T, S, A, and L under the assumption that the fuel rod neutron production rate P is an unknown value.

By doing this, calculation of the response matrix can be omitted, a calculation amount can be significantly reduced, and a calculation time can be significantly reduced. Stated another way, the first problem described above in a case where the direct response matrix method is applied can be solved.

Furthermore, in the present example, the neutron effective multiplication factor k is directly evaluated, by using the response relationships Fs, Cs, Ff, and Cf with neutron flux or the macroscopic cross sections.

By doing this, convergence can be improved, and a calculation time can be significantly reduced in comparison with a method for performing adjustment on the basis of an increase/decrease in neutron current according to the direct response matrix method. Stated another way, the second problem described above in a case where the direct response matrix method is applied can be solved.

### Example 2

A core performance calculation apparatus in Example 2 of the present invention is described below.

An apparatus configuration of the core performance calculation apparatus in the present example is the same as an apparatus configuration of the core performance calculation apparatus 1 in Example 1.

A nuclear constant that has been stored in the nuclear constant storage device 5 in the present example is the four types of response relationships that are the same as response relationships in the direct response matrix method, and includes the response relationship (T) between a neutron that flows into a fuel assembly cell and a neutron that flows out from the fuel assembly cell, the response relationship (S) between the neutron that flows into the fuel assembly cell and a neutron that is produced from a fuel rod, the response relationship (A) between the neutron that is produced from the fuel rod and a neutron that is produced from another fuel rod due to a fission reaction that has been induced by the neutron that is produced from the fuel rod, and the response relationship (L) between the neutron that is produced from the fuel rod and the neutron that flows out from the fuel assembly cell.

The present example is different from Example 1 in that the response relationships Fs, Cs, Ff, and Cf with neutron flux or macroscopic cross sections have not been stored in the nuclear constant storage device 5.

In the present example, the response relationships Fs, Cs, Ff, and Cf with the neutron flux or the macroscopic cross sections have not been stored. Therefore, convergence of repetitive calculation for obtaining the neutron effective multiplication factor k fails to be improved.

However, in the present example, similarly to Example 1, neutron current and a fuel rod neutron production rate can be obtained without obtaining a response matrix.

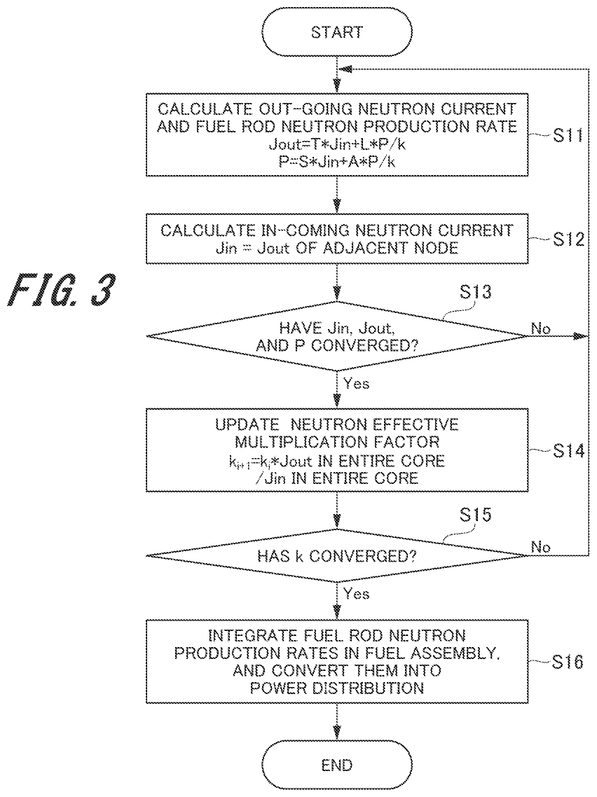

Here, a flowchart of an outline of a flow of power distribution calculation performed by the three-dimensional core nuclear thermal-hydraulic characteristics analysis device 6 of the core performance calculation apparatus in Example 2 of the present invention is illustrated in FIG. 3.

First, in step S11, out-going neutron current Jout is calculated by using four types of response relationships T, S, A, and L, in-coming neutron current Jin, a fuel rod neutron production rate P, and a neutron effective multiplication factor k, and the fuel rod neutron production rate P is updated.

Stated another way, similarly to step S1 of FIG. 2, the out-going neutron current Jout is calculated according to Formula (1) described below, and the fuel rod neutron production rate P is updated according to Formula (2).

Jout=T*Jin+L*P/k (1)

P=S*Jin+A*P/k (2)

Next, in step S12, in-coming neutron current of each node is set to out-going neutron current of an adjacent node, and the in-coming neutron current Jin is calculated.

Stated another way, setting is performed in such a way that Jin=Jout of an adjacent node.

Moreover, this calculation of the neutron current and the fuel rod neutron production rate is repeated until convergence.

Stated another way, in step S13, it is determined whether the in-coming neutron current Jin, the out-going neutron current Jout, and the fuel rod neutron production rate P have converged, and if they have converged, the processing moves on to step S14, and if they have not converged, the processing returns to step S11.

In step S14, ratios of the out-going neutron current and the in-coming neutron current in the entire core are multiplied, and therefore the neutron effective multiplication factor k is updated. Stated another way, similarly to step S25 of FIG. 4, the neutron effective multiplication factor k is updated, as expressed by Formula (13) described below.

kᵢ₊₁=kᵢ*Jout in entire core/Jin in entire core (13)

where kᵢ is a neutron effective multiplication factor in i-th repetition, and kᵢ₊₁ is a neutron effective multiplication factor in (i+1)th repetition.

Next, out-going neutron current Jout is calculated by using the updated neutron effective multiplication factor k, and the fuel rod neutron production rate P is updated. Calculation of the out-going neutron current Jout and updating of the fuel rod neutron production rate P are repeated until the neutron effective multiplication factor k has converged.

Stated another way, in step S15, it is determined whether the neutron effective multiplication factor k has converged. In a case where the neutron effective multiplication factor k has not converged, the processing returns to step S11, the out-going neutron current Jout is calculated, and the fuel rod neutron production rate P is updated. In contrast, in a case where the neutron effective multiplication factor k has converged, the processing moves on to step S16.

After the neutron effective multiplication factor k has converged, a power distribution in a core is calculated by using the obtained in-coming neutron current and the response relationships.

Stated another way, in step S16, the calculated fuel rod neutron production rates are integrated in the fuel assembly, and a result is converted into a power distribution.

In the present example, the neutron effective multiplication factor k and a power distribution of a fuel assembly are obtained, by using, as nuclear constants, the response relationships T, S, A, and L without using homogenized cross sections.

By doing this, the response relationships T, S, A, and L are not homogenized in a fuel assembly cell. Therefore, the assumption of evaluation of the nuclear constant can also be adapted to a core in which adjacent fuel assemblies are different in nuclear characteristics, and can be applied without problems.

Furthermore, diffusion approximation is not used in calculating a power distribution. Therefore, an error is not generated due to diffusion approximation, and a power distribution in a core can be obtained with high precision in comparison with a conventional core performance calculation apparatus.

In particular, even in the case of a core in which adjacent fuel assemblies are significantly different in nuclear characteristics, a power distribution in the core can be obtained with high precision.

Furthermore, in the present example, similarly to Example 1, a response matrix that would be obtained in the direct response matrix method is not obtained, and in-coming/out-going neutron currents Jin and Jout and a fuel rod neutron production rate P are obtained, by using four types of response relationships T, S, A, and L under the assumption that the fuel rod neutron production rate P is an unknown value.

By doing this, calculation of the response matrix can be omitted, a calculation amount can be significantly reduced, and a calculation time can be significantly reduced. Stated another way, the first problem described above in a case where the direct response matrix method is applied can be solved.

(Variations)

In Example 2 described above, from among the two problems in a case where the direct response matrix method is applied, only the first problem has been solved. However, only the second problem in a case where the direct response matrix method is applied can also be solved. For example, if the fuel rod neutron production rate P is calculated and updated together with calculation of the out-going neutron current in step S22 of FIG. 4, and processes that are similar to the processes of steps S4 to S8 of FIG. 2 are performed after Jin, Jout, and P have converged, the second problem can be solved.

Note that the present invention is not limited to the embodiments and the examples that have been described above, and includes a variety of variations. For example, each of the embodiments and the examples that have been described above has been described in detail in order to make the present invention easily understandable, and the present invention is not necessarily limited to an embodiment or an example in which all of the described configurations are included.

What is claimed is:

1. A core performance calculation apparatus comprising:
a nuclear constant storage device that stores nuclear constants that have been evaluated in advance in analysis of a fuel assembly; and a three-dimensional core nuclear thermal-hydraulic characteristics analysis device that obtains core characteristics including a power of the fuel assembly, wherein
the nuclear constant storage device stores, as the nuclear constants, response relationships between a neutron that flows into a fuel assembly cell and fuel assembly nuclear characteristics, and response relationships between a neutron that is produced from a fuel rod and the fuel assembly nuclear characteristics, and
the three-dimensional core nuclear thermal-hydraulic characteristics analysis device obtains a neutron effective multiplication factor by using a plurality of the response relationships that have been stored in the nuclear constant storage device, and obtains the power of the fuel assembly by using the neutron effective multiplication factor.

2. The core performance calculation apparatus according to claim 1, wherein the three-dimensional core nuclear thermal-hydraulic characteristics analysis device performs: calculating out-going neutron current by using the response relationships between the neutron that flows into the fuel assembly cell and the fuel assembly nuclear characteristics, the response relationships between the neutron that is produced from the fuel rod and the fuel assembly nuclear characteristics, in-coming neutron current, a fuel rod neutron production rate, and the neutron effective multiplication factor, and updating the fuel rod neutron production rate; setting the in-coming neutron current of each node to the out-going neutron current of an adjacent node; and repeating the calculating of the out-going neutron current and the updating of the fuel rod neutron production rate, until the in-coming neutron current, the out-going neutron current, and the fuel rod neutron production rate have converged.

3. The core performance calculation apparatus according to claim 1, wherein the response relationships with the fuel assembly nuclear characteristics includes the response relationship between the neutron that flows into the fuel assembly cell and the neutron that flows out from the fuel assembly cell, the response relationship between the neutron that flows into the fuel assembly cell and the neutron that is produced from the fuel rod, the response relationship between the neutron that is produced from the fuel rod and the neutron that is produced from another fuel rod due to a fission reaction that has been induced by the neutron that is produced from the fuel rod, and the response relationship between the neutron that is produced from the fuel rod and the neutron that flows out from the fuel assembly cell.

4. The core performance calculation apparatus according to claim 1, wherein the three-dimensional core nuclear thermal-hydraulic characteristics analysis device obtains the neutron effective multiplication factor, by using the response relationship between the neutron that flows into the fuel assembly cell and neutron flux, the response relationship between the neutron that flows into the fuel assembly cell and macroscopic cross sections, the response relationship between the neutron that is produced from the fuel rod and the neutron flux, and the response relationship between the neutron that is produced from the fuel rod and the macroscopic cross sections.

5. The core performance calculation apparatus according to claim 1, wherein the response relationships with the fuel assembly nuclear characteristics includes the response relationship between the neutron that flows into the fuel assembly cell and the neutron that flows out from the fuel assembly cell, the response relationship between the neutron that flows into the fuel assembly cell and the neutron that is produced from the fuel rod, the response relationship between the neutron that is produced from the fuel rod and the neutron that is produced from another fuel rod due to a fission reaction that has been induced by the neutron that is produced from the fuel rod, the response relationship between the neutron that is produced from the fuel rod and the neutron that flows out from the fuel assembly cell, the response relationship between the neutron that flows into the fuel assembly cell and neutron flux, the response relationship between the neutron that flows into the fuel assembly cell and macroscopic cross sections, the response relationship between the neutron that is produced from the fuel rod and the neutron flux, and the response relationship between the neutron that is produced from the fuel rod and the macroscopic cross sections.
